(19) United States
(12) Patent Application Publication
(10) Pub. No.: US 2025/0207222 A1
(43) Pub. Date: Jun. 26, 2025

(54) THERMO-HYDROLYTIC ASSISTED SEPARATION OF METALS

(71) Applicant: Iowa State University Research Foundation, Inc., Ames, IA (US)

(72) Inventors: Denis Prodius, Ames, IA (US); Ikenna Cajetan Nlebedim, Ames, IA (US); Anirudha Karati, Ames, IA (US)

(73) Assignee: Iowa State University Research Foundation, Inc., Ames, IA (US)

(21) Appl. No.: 18/987,240

(22) Filed: Dec. 19, 2024

Related U.S. Application Data
(60) Provisional application No. 63/612,783, filed on Dec. 20, 2023.

(51) Int. Cl. C22B 59/00; C22B 3/22; C22B 7/00

(52) U.S. Cl. CPC C22B 59/00; C22B 3/22; C22B 7/001; C22B 7/007

(57) ABSTRACT

Embodiments of a process are provided. In the process, a rare earth (RE) element is added to an aqueous feedstock including a first salt of the RE element and a second salt of a metal to form a mixture. The mixture is heated to a temperature of at least 50° C. to cause hydrolysis of the second salt to form a precipitate of a hydroxide comprising the metal and to cause an increase in a concentration of the first salt or formation of a third salt comprising the RE element. The precipitate is separated from the mixture, and the first salt or the third salt in the mixture is reacted with an oxalate to precipitate a RE oxalate. The RE oxalate is separated from the mixture, and the RE oxalate is calcined to form the RE element.

### CROSS-REFERENCE TO RELATED PATENT APPLICATIONS

This patent application claims the benefit of U.S. Provisional Patent Application No. 63/612,783, filed Dec. 20, 2023, the entire teachings and disclosure of which are incorporated herein by reference thereto.

### STATEMENT REGARDING FEDERALLY SPONSORED RESEARCH AND DEVELOPMENT

This invention was made with government support under DE-AC02-07CH11358 awarded by the Department of Energy. The government has certain rights in the invention.

### FIELD OF THE INVENTION

This invention generally relates to a process for the production or recovery of rare earth materials and, in particular, to a thermo-hydrolytic assisted separation of rare earth elements from other metals.

### BACKGROUND OF THE INVENTION

Modern technologies utilize materials that include a broad palette of finely intermixed elements to achieve desirable properties. The intermixed elements may impose limits on the recyclability of such materials. For electronics waste (“e-waste”), recyclability is desirable because recycling e-waste can significantly decrease the necessity for energy-intensive mining of valuable metals, reduce pollution and greenhouse gas emissions, save natural resources, and reinsert valuable raw materials into the product lifecycle. For example, the improved recovery of rare earth (RE) elements either from natural sources (e.g., mines) or end-of-life materials (e.g., e-waste and industrially generated waste) can have great global benefits in ensuring a sustainable supply of RE elements with reduced potential for disruption.

The recovery and separation of individual elements from the complex systems of finely intermixed materials often requires complex energy-consuming solutions (pyrometallurgical, electrochemical, and melt processing), with many hazardous chemicals (hydrothermal) used. Although more recent approaches such as the use of supercritical gas, bioleaching, and the usage of transition metal salts are favorable lab-scale approaches, their transfer to industrial exploration still requires significant adjustments. About 10 to 15 percent of the U.S. total energy consumption is spent on chemical separations. Furthermore, the RE element market is projected to make a significant jump to an estimated $9.6 billion by 2026 from $5.3 billion in 2021. Thus, there exists significant pressure on the development of separation chemistries in the need to balance efficiency, sustainability, and environmental impacts. Lack of proper balance leads to negative impacts on investments, end-product prices, and other economic development opportunities.

### BRIEF SUMMARY OF THE INVENTION

According to embodiments described herein, thermo-hydrolytic assisted separation of rare earth elements from metals has been developed as a potential solution to the negative economic impacts that, in addition, will reduce the environmental and energy obstacles. These and other advantages of the invention, as well as additional inventive features, will be apparent from the description of the invention provided herein.

In a first aspect, embodiments of the disclosure relate to a process. In the process, a rare earth (RE) element is added to an aqueous feedstock including a first salt of the RE element and a second salt of a metal to form a mixture. The mixture is heated to a temperature of at least 50° C. to cause hydrolysis of the second salt to form a precipitate of a hydroxide comprising the metal and to cause an increase in a concentration of the first salt or formation of a third salt comprising the RE element. The precipitate is separated from the mixture, and the first salt or the third salt in the mixture is reacted with an oxalate source to precipitate a RE oxalate. The RE oxalate is separated from the mixture, and the RE oxalate is calcined to form the RE oxide.

In a second aspect according to the process of the first aspect, during adding, the RE element is produced from the calcining step of the process previously performed.

In a third aspect according to the process of the first or second aspect, the first salt and the second salt comprise salts of Cl⁻, NO₃⁻, CH₃COO⁻, or ½SO₄²⁻.

In a fourth aspect according to any of the first through third aspects, heating comprises heating the mixture using a microwave, a burner, a furnace, an oven, a hot plate, a heat pump, solar energy, or an induction coil.

In a fifth aspect according to any of the first through fourth aspects, heating comprises heating the mixture using a microwave operated at a power in a range from 75 W to 200 W.

In a sixth aspect according to any of the first through fifth aspects, during heating, the mixture is maintained at a pressure of 100 psi or less.

In a seventh aspect according to any of the first through the sixth aspects, during heating, the mixture is heated to a temperature of 150° C. or less.

In an eighth aspect according to any of the first through seventh aspects, the RE element is in a form of a RE oxide.

In a ninth aspect according to any of the first through the eighth aspects, the RE element is in a form of a RE hydroxide.

In a tenth aspect according to any of the first through the ninth aspects, the oxalate is oxalic acid or ammonium oxalate.

In an eleventh aspect according to any of the first through tenth aspects, the metal comprises one or more transition metals.

In a twelfth aspect according to any of the first through eleventh aspects, the RE element comprises at least one of Sc, Y, La, Ce, Nd, Pr, Sm, Eu, Gd, Tb, Dy, Ho, Er, Tm, Yb, or Lu.

In a thirteenth aspect according to any of the first through twelfth aspects, adding further comprises adding a hydroxide and the rare earth (RE) element to the aqueous feedstock.

In a fourteenth aspect according to any of the first through the thirteenth aspects, the RE element comprises no more than 0.5 wt % of transition metal impurities.

In a fifteenth aspect according to any of the first through the fourteenth aspects, reacting takes place at room temperature while stirring the mixture.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a flow diagram of a process for extracting rare earth elements from other metals in a feedstock, according to an exemplary embodiment; and

FIG. 2 is an X-ray fluorescence (XRF) spectrum for rare earth elements recovered from a feedstock, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of the present disclosure relate to extracting or separating rare earth (RE) elements from other metals in a process where the extracted RE element (e.g., in the form of an oxide or hydroxide) is fed back into the extraction reaction. In particular, the process involves adding extracted RE elements to a RE feedstock to drive a (thermally-assisted) hydrolytic reaction that separates the RE element from other metals contained in the feedstock. In certain embodiments, twice as much RE element is produced than is fed back into the reaction to drive the separation reaction forward. Advantageously, the process limits the introduction of additional chemicals into the extraction process and allows for the separation of highly purified RE elements. In particular, Applicant has found that using the process, RE elements can be extracted from feedstock at yields of ≥95%, in particular ≥99%, purity. These and other aspects and advantages of the disclosed thermo-hydrolytic RE element separation process will be described in greater detail below. The embodiments and examples are provided by way of illustration, not limitation.

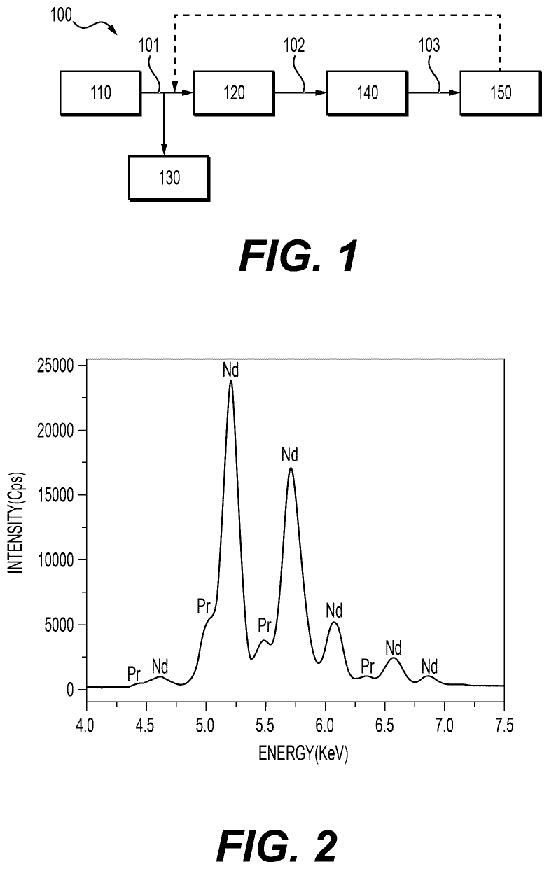

FIG. 1 provides a flow diagram of process 100 for extracting RE elements from a feedstock. As shown in FIG. 1, process 100 starts with a rare earth material feedstock 110, such as e-waste or mineral ore, in the form of an aqueous solution of metal salts. Various techniques for dissolving e-waste or mineral ore in acid to produce such aqueous solutions are known in the art. In one or more embodiments, metals, including the RE element, may be dissolved or leached from the e-waste or mineral ore using hydrochloric acid, nitric acid, acetic acid, or sulfuric acid to form the aqueous solution of metal salts.

In one or more embodiments, the e-waste is, for example, permanent magnets from end-of-life electronic products, such as computer disc drives, electric motors, or batteries, among other possibilities; magnet scrap material, such as cuttings, grinding swarfs, and polishing byproducts, generated by magnet manufacturing and processing; and magnet powders generated by hydrogen decrepitation, grinding, and other material pulverization processes; Terfenol-D alloy; RE-Fe and other RE-Fe-M materials where Fe is iron and M can be any other element. For electronic materials containing rare-earth magnet such as computer hard disc drives, the RE-containing component can be pre-concentrated, or it can be processed in the as-shredded condition without pre-sorting and thermal demagnetization.

According to the first reaction 101 of the process 100, the RE material feedstock 110 is reacted with RE oxide (RE₂O) and water. In one or more embodiments, the first reaction 101 may also involve reacting the RE feedstock 110 with a hydroxide, such as sodium hydroxide. In one or more embodiments, the reaction takes place in a sealed vessel while being heated. In one or more embodiments, the pressure in the sealed vessel is 100 psi or less, 90 psi or less, 80 psi or less, or 70 psi or less. In one or more embodiments, the pressure in the sealed vessel is at least 100 psi. In one or more embodiments, the temperature during the reaction is maintained at 150° C. or less, 140° C. or less, 130° C. or less, or 120° C. or less. In one or more embodiments, the temperature during the reaction is at least 50° C.

The reaction can be heated using any of a variety of different heating sources, such as a microwave, burner, furnace, oven, hot plate, induction coil, heat pumps, solar energy, among other possibilities. In one or more particular embodiments, a microwave is used to provide the heating during the reaction. In such embodiments, the microwave is operated at 200 W or less, 175 W or less, 150 W or less, 125 W or less, 100 W or less. Further, in such embodiments, the microwave is operated at 75 W or more. A microwave-assisted heating process, in particular, transfers electromagnetic energy to thermal energy and induces chemical reactions through volumetric heating without breaking any bonds. Further, microwave-assisted heating has been observed, in certain experimental examples, to improve reaction rates, decrease reaction time, and improve yield.

As will be discussed more fully below, the RE oxide may be a portion of the RE oxide produced as a product during process 100. That is, RE oxide produced during the process is fed back into the process to stimulate production of RE oxide from the RE material feedstock. Equation 1, below, describes an example of a first reaction 101 considering a rare earth material feedstock of a RE magnet (e.g., Nd₂Fe₁₄B).

RE₂O₃+{2FeX₃+REX₃}+3H₂O→3REX₃+2Fe(OH)₃↓ (1)

In Equation 1, X is one or more of Cl⁻, NO₃⁻, CH₃COO⁻, or ½SO₄²⁻. According to the first reaction, the RE oxide hydrolytically dissolves and forms salts with the anions of the iron salt. The oxygen from the rare earth oxide and the hydrogen and oxygen from the water react with the iron salt to form iron hydroxide. Some or all of the iron hydroxide will decompose to form iron oxide and water according to Equation 2, below.

2Fe(OH)₃↓→Fe₂O₃+3H₂O (2)

Thus, the products of the first reaction 101, according to Equations 1 and 2, are RE salts 120, and iron hydroxide/iron oxide 130, and the iron hydroxide/iron oxide 130 will precipitate from the mixture, allowing it to be separated. Thus, after the first reaction 101, the RE elements are separated from the transition metals that are typically found with the RE elements in e-waste or mineral ore.

To separate the RE salts 120 from the solution, the RE salts 120 are reacted in a second reaction 102 with an oxalate compound, such as ammonium oxalate or oxalic acid, according to Equation 3, below:

2REX₃+3(NH₄)₂C₂O₄+nH₂O→RE₂(C₂O₄)₃·nH₂O↓+6NH₄X, where n≥6 (3)

The reaction of Equation 3 can be performed while stirring the reactants at room temperature over a time period of, e.g., 20 minutes. As can be seen from Equation 3, the ammonium forms a salt with the anion of the RE salt, and the RE element forms a hydrated oxalate compound 140, which precipitates from the solution. The precipitated RE oxalate 140 can be separated from the solution by filtration.

The RE oxalate precipitate is then washed with water one or more times, and in a third reaction 103, the RE oxalate is calcined as shown in Equation 4 to obtain RE oxide:

2RE₂(C₂O₄)₃·nH₂O+3O₂→2RE₂O₃+12CO₂↑+2nH₂O (4)

Calcining the RE oxalate 140 causes the RE oxalate 140 to dehydrate and decompose, producing RE oxide 150, carbon dioxide gas, and water. As mentioned above, the RE oxide 150 produced during the process may be utilized in the first reaction to stimulate the initial reaction. From Equations 1-4, it can be seen that, stoichiometrically, twice as much RE oxide is produced as is fed back into the reaction.

Advantageously, in one or more embodiments, the yield of rare earth oxide from the rare earth material feedstock is at least 95%, and the purity of rare earth element in the oxide is at least 95% and can be 99% or greater. Further, the process is environmentally benign and in line with the principles of green chemistry, especially the principles of atom economy, less hazardous chemical syntheses, design for energy efficiency, reduce derivatives, and use of renewable feedstock.

### EXAMPLES

### Example 1—Separation of RE Elements from Mixture with Iron (II/III) Ions by Using Recycled RE₂O₃ or RE₂O₃/Fe-Oxides Mixture as a Reagent

In a first example, RE elements were recovered from waste Nd₂Fe₁₄B magnets. Using X-ray fluorescence (XRF) analysis, it was determined that the composition of the magnets was 80.89 wt % Fe, 0.38 wt % Co, 0.01 wt % Cu, 4.28 wt % Pr, and 14.43 wt % Nd. The magnets were dissolved in hydrochloric acid, producing an aqueous solution containing iron chlorides and RE chlorides. To 10 ml of this aqueous solution, RE oxide (RE₂O₃) was added, and the solution was stirred and heated for three minutes to a maximum temperature of 138° C. and to a maximum pressure of 87 psi using a microwave heater at 90 W power.

A red-brown precipitate formed after the solution was stirred and heated, which Applicant determined to be iron hydroxide and iron oxide. The precipitate was separated from the mixture by decanting the liquid. To the liquid, ammonium oxalate was added at room temperature and stirred for 20 minutes. A precipitate was formed, which Applicant determined to be RE oxalate.

The RE oxalate was separated by filtration, washed with water, and calcined to obtain RE oxide. Using XRF, the RE portion of the RE oxide was determined to be 77.32 wt % Nd and 22.62 wt % Pr with <0.1 wt % of impurities. The XRF spectrum can be seen in FIG. 2.

### Example 2—Purification of RE Elements from Mixture with Transition Metal Traces

The above-described process was used to remove transition metal traces from mixtures with the RE elements, such as copper (Cu) and cobalt (Co). RE feedstock was provided in the form of NdFeB magnets dissolved with Cu(II) salts. RE oxide and water were added to the RE feedstock as shown in Equation 7, below:

RE₂O₃+6CuX₂+3H₂O→2REX₃+6Cu(OH)X↓ (7)
where X is Cl⁻, NO₃⁻, CH₃COO⁻, or ½SO₄²⁻. In the case of acetate salt of copper, the mixture was heated at about 80° C. (e.g., using a hot plate) to promote the decomposition of the copper acetate to copper (II) oxide as shown in Equation 8, below:

Cu(OH)(CH₃COO)↑→CuO↓+CH₃COOH↑ (8)

After separating and calcining the RE oxalate, the extracted RE oxide contained >99.5 wt %, in particular >99.9 wt %, of RE metals (Pr and Nd) with only 0.05 wt % of Ni and no copper or cobalt detected.

Based on these results, Applicant expects that trace metals, such as Cu, Al, Co and Ga, among other transition metals, can be removed from Nd—Fe—B magnets as well as Sm-based magnets, known to contain such trace metals as Co, Fe, Cu, and Zr. Further, Applicants expect that trace transition metals can be removed from RE compounds containing Gd.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A process, comprising:
adding a rare earth (RE) element to an aqueous feedstock comprising a first salt of the RE element and a second salt of a metal to form a mixture;
heating the mixture to a temperature of at least 50° C. to cause hydrolysis of the second salt to form a precipitate of a hydroxide comprising the metal and to cause an increase in a concentration of the first salt or formation of a third salt comprising the RE element;
separating the precipitate from the mixture;
reacting the first salt or the third salt in the mixture with an oxalate to precipitate a RE oxalate;
separating the RE oxalate from the mixture; and
calcining the RE oxalate to form the RE element.

2. The process of claim 1, wherein, during adding, the RE element is produced from the calcining step of the process previously performed.

3. The process of claim 1, wherein the first salt and the second salt comprise salts of Cl⁻, NO₃⁻, CH₃COO⁻, or ½SO₄²⁻.

4. The process of claim 1, wherein heating comprises heating the mixture using a microwave, a burner, a furnace, an oven, a hot plate, a heat pump, solar energy, or an induction coil.

5. The process of claim 1, wherein heating comprises heating the mixture using a microwave operated at a power in a range from 75 W to 200 W.

6. The process of claim 1, wherein, during heating, the mixture is maintained at a pressure of 100 psi or less.

7. The process of claim 1, wherein, during heating, the mixture is heated to a temperature of 150° C. or less.

8. The process of claim 1, wherein the RE element is in a form of a RE oxide.

9. The process of claim 1, wherein the RE element is in a form of a RE hydroxide.

10. The process of claim 1, wherein the oxalate is oxalic acid or ammonium oxalate.

11. The process of claim 1, wherein the metal comprises one or more transition metals.

12. The process of claim 1, wherein the RE element comprises at least one of Sc, Y, La, Ce, Nd, Pr, Sm, Eu, Gd, Tb, Dy, Ho, Er, Tm, Yb, or Lu.

13. The process of claim 1, wherein adding further comprises adding a hydroxide and the rare earth (RE) element to the aqueous feedstock.

14. The process of claim 1, wherein the RE element comprises no more than 0.5 wt % of transition metal impurities.

15. The process of claim 1, wherein reacting takes place at room temperature while stirring the mixture.
